(19) United States
(12) Patent Application Publication
(10) Pub. No.: US 2026/0295508 A1
(43) Pub. Date: Oct. 1, 2026

(54) HIGH-EFFICIENCY CARBONATION REACTION SYSTEM AND METHOD FOR CAPTURING CARBON DIOXIDE FROM FLUE GAS CONTINUOUSLY

(71) Applicant: National Atomic Research Institute, Taoyuan City (TW)

(72) Inventors: YU-ZHEN ZENG, Taoyuan City (TW); HSIAN-CHANG KUO, Taoyuan City (TW); RUEY-YU CHAN, Taoyuan City (TW); CHUN-CHI HOU, Taoyuan City (TW)

(21) Appl. No.: 19/096,710

(22) Filed: Mar. 31, 2025

(51) Int. Cl. B01D 53/14; B01D 53/18; B01D 53/62; B01D 53/75; B01D 53/79

(52) U.S. Cl. CPC B01D 53/1406; B01D 53/1475; B01D 53/1493; B01D 53/185; B01D 53/62; B01D 53/75; B01D 53/79; B01D 2251/304; B01D 2251/604; B01D 2257/504; B01D 2258/0283

(57) ABSTRACT

A reaction system for capturing CO₂ which comprises a filler material chamber and a bubble chamber is disclosed. The filler material chamber internally comprises a filler material. A first liquid material flow of an aqueous solution containing alkali metal ions enters the filler material chamber to undergo carbonation reaction to form a second liquid material flow which leaves the filler material chamber and enters the bubble chamber to undergo carbonation reaction to form a third liquid material flow which leaves the bubble chamber. A first gas material flow containing CO₂ enters the bubble chamber in a form of bubbles to undergo carbonation reaction with the second liquid material flow to form a second gas material flow which leaves the bubble chamber and enters the filler material chamber to undergo carbonation reaction with the first liquid material flow to form a third gas material flow which leaves the filler material chamber.

### TECHNICAL FIELD

The present disclosure relates to a reaction system and a method for capturing carbon dioxide, particularly to a reaction system and a method for capturing carbon dioxide through carbonation reaction.

### BACKGROUND

Carbon dioxide conversion is a forward-looking science technology actively developed by countries around the world. At present, advanced countries are still in the stage of technical development, testing, and validation. In numerous carbon dioxide conversion processes, regardless of whether they are converted into fuels or chemicals, their Gibbs energy (ΔG) changes are all >0, indicating that this purpose is achieved by adding additional energy. By contrast, a carbonation reaction of carbon dioxide is a thermodynamically favored conversion pathway, which is an exothermic reaction and belongs to a spontaneous reaction because its Gibbs energy change is negative. The Gibbs energy of the product is lower than that of carbon dioxide itself, and there is no need to consume lots of energy to convert carbon dioxide into a stable carbonate (bicarbonate) product so as to achieve the effects of carbon dioxide recycling and carbon reduction.

For example, the carbonation reaction of carbon dioxide is that a flue gas containing carbon dioxide is introduced into an alkaline solution of alkali metal hydroxide for reaction, which is composed of a two-step reaction represented by Equation (1) and a reaction represented by Equation (2). In the reaction process, carbon dioxide initially reacts with an alkaline solution to form carbonate, and then the carbonate further reacts with carbon dioxide to form bicarbonate. Here, by taking sodium as an example of an alkali metal, a total reaction equation is represented as Equation (3).

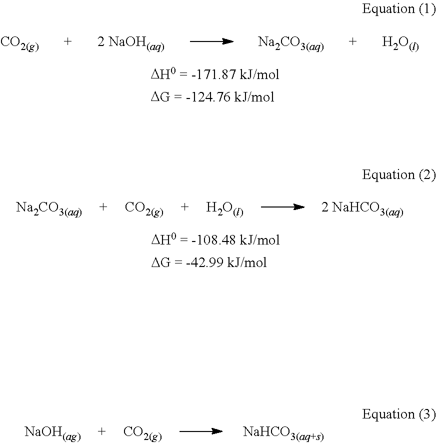

The reaction represented by Equation (1) and the reaction represented by Equation (2) are both exothermic reactions (ΔH⁰<0) and spontaneous reactions (ΔG<0), and the Gibbs energy of the reaction represented by Equation (2) is lower than that of the reaction represented by Equation (1), indicating that the reaction represented by Equation (2) is relatively slow, and this step is a rate-determining step for the entire carbonation reaction. However, as shown in FIG. 1, the carbonation reaction that usually starts from an alkaline solution in the prior art only uses a single bubble bed reactor 20 throughout the reaction process, and therefore the entire carbon dioxide absorption rate and the carbonate (bicarbonate) yield are affected. In other words, it is difficult to simultaneously achieve the two purposes of a high carbon dioxide absorption rate and a high carbonate (bicarbonate) yield.

In another aspect, to allow a gas to have a sufficient interface area to contact with a liquid, a gas sprayer is arranged at a gas inlet of a generally common bubble bed reactor, where the fed gas forms micron-level bubbles by utilizing superfine openings to sufficiently contact and react with the liquid. Furthermore, to achieve a uniform radial distribution of the gas inside the reactor, the size of the gas sprayer increases as an inner diameter of a tower increases. The size of the openings of the gas sprayer is related to the retention time and reaction area of a gas for gas reaction. Although small openings can generate bubbles with sufficient interface areas to improve reaction efficiency, too small openings in a bubble bed reactor with concurrent gas, liquid, and solid phases may cause blockage of the openings due to solid precipitation and accumulation on the gas sprayer, affecting the continuous progress of the reaction; however, too large openings may increase size of bubbles and shorten the retention time in the reactor, which may lead to a decrease in the efficiency of the gas-liquid reaction.

### SUMMARY

The objective of the present disclosure is to provide a reaction system for capturing carbon dioxide through carbonation reaction, which can simultaneously achieve the two purposes of a high carbon dioxide absorption rate and a high carbonate (bicarbonate) yield.

Another objective of the present disclosure is to provide a reaction system for capturing carbon dioxide through carbonation reaction, which can reduce the effect of solid precipitation on the reaction progress.

The objective of the present disclosure is to provide a reaction method for capturing carbon dioxide through carbonation reaction, which can simultaneously achieve two purposes of a high carbon dioxide absorption rate and a high carbonate (bicarbonate) yield.

Another objective of the present disclosure is to provide a reaction method for capturing carbon dioxide through carbonation reaction, which can reduce the effect of solid precipitation on the reaction progress.

The reaction system for capturing carbon dioxide through carbonation reaction of the present disclosure comprises a filler material chamber and a bubble chamber. The filler material chamber internally comprises a filler material. A first liquid material flow of an aqueous solution containing alkali metal ions enters the filler material chamber to undergo carbonation reaction to form a second liquid material flow which leaves the filler material chamber, and the second liquid material flow enters the bubble chamber to undergo carbonation reaction to form a third liquid material flow which leaves the bubble chamber. A first gas material flow containing carbon dioxide enters the bubble chamber in a form of bubbles to undergo carbonation reaction with the second liquid material flow to form a second gas material flow which leaves the bubble chamber, and the second gas material flow enters the filler material chamber to undergo carbonation reaction with the first liquid material flow to form a third gas material flow which leaves the filler material chamber.

In an embodiment, the concentration of carbon dioxide in the first gas material flow is greater than that in the second gas material flow, and the concentration of carbon dioxide in the second gas material flow is greater than that in the third gas material flow.

In an embodiment, the reaction system further comprises a microbubble generation device, wherein the first gas material flow enters the microbubble generation device to be mixed with a part of the second liquid material flow leaving the filler material chamber and form a plurality of microbubbles, and then enters the bubble chamber.

In an embodiment, the reaction system further comprises a microbubble generation device, wherein the first gas material flow enters the microbubble generation device to be mixed with a part of the third liquid material flow leaving the bubble chamber and form a plurality of microbubbles, and then enters the bubble chamber.

In an embodiment, the first gas material flow enters the bubble chamber from the side wall of the bubble chamber.

In an embodiment, the diameter of the microbubble is less than 100 μm.

In an embodiment, the microbubble generation device comprises a stirrer which is used for stirring so that the first gas material flow forms the microbubbles.

In an embodiment, the first liquid material flow is an alkali metal hydroxide aqueous solution.

The present disclosure provides a reaction method for capturing carbon dioxide through carbonation reaction, comprising: providing a filler material chamber internally comprising a filler material; providing a bubble chamber; providing the first liquid material flow of an aqueous solution containing alkali metal ions, so that the first liquid material flow enters the filler material chamber to undergo carbonation reaction to form the second liquid material flow which leaves the filler material chamber, and the second liquid material flow enters the bubble chamber to undergo carbonation reaction to form the third liquid material flow which leaves the bubble chamber; and providing the first gas material flow containing carbon dioxide, so that the first gas material flow enters the bubble chamber in a form of bubbles to undergo carbonation reaction with the second liquid material flow to form the second gas material flow which leaves the bubble chamber, and the second gas material flow enters the filler material chamber to undergo carbonation reaction with the first liquid material flow to form the third gas material flow which leaves the filler material chamber.

In an embodiment, the step of providing the first gas material flow comprises: providing the first gas material flow which is mixed with a part of second liquid material flow leaving the filler material chamber and forms a plurality of microbubbles.

In an embodiment, the step of providing the first gas material flow comprises: providing the first gas material flow which is mixed with a part of the third liquid material flow leaving the bubble chamber and forms a plurality of microbubbles.

In an embodiment, the reaction method comprises: allowing the first gas material flow to enter the bubble chamber from the side wall of the bubble chamber.

In an embodiment, the reaction method comprises: stirring so that the first gas material flow forms the microbubbles.

In an embodiment, the reaction system comprises a bubble chamber and a microbubble generation device. Where, a part of a raw liquid material flow of an aqueous solution containing alkali metal ions enters the bubble chamber to undergo carbonation reaction to form a product liquid material flow which leaves the bubble chamber. A raw gas material flow containing carbon dioxide enters the microbubble generation device to be mixed with a part of the raw liquid material flow and form a plurality of microbubbles, and then enters the bubble chamber to undergo carbonation reaction with the raw liquid material flow to form a residual gas material flow which leaves the bubble chamber.

### BRIEF DESCRIPTION OF THE DRAWINGS

FIG. 1 is a diagram of the prior art.

FIG. 2 is a diagram of an embodiment of a reaction system according to the present disclosure.

FIG. 3 is a diagram of a different embodiment of a reaction system according to the present disclosure.

FIG. 4 is a flowchart of an embodiment of a reaction method according to the present disclosure.

FIG. 5 is a variation diagram of a CO₂ conversion rate in embodiment 1.

FIG. 6A and FIG. 6B are scanning electron microscopy (SEM) images.

FIG. 7A and FIG. 7B are variation diagrams of pH values in a bubble chamber in embodiment 1 and a comparative example, respectively

### DETAILED DESCRIPTION

Next, the embodiments of the connection assemblies disclosed in the present disclosure will be illustrated through specific embodiments in combination with drawings. The advantages and effects of the present disclosure will be known by those skilled in the art according to the contents disclosed in this specification. However, the following disclosed contents are not intended to limit the scope of protection of the present disclosure, and the present disclosure is achieved through other different embodiments based on different viewpoints and applications without departing from the spirit of the present disclosure. In the figures, for clarity, the thicknesses of layers, films, panels, regions and the like have been enlarged. Throughout the entire specification, the same reference number represents the same element. It should be understood that when an element such as layer, film, region or substrate is referred to as being “on” or “connected to” another element, the element can be directly on another element or connected with another element, or a middle element can be present. On the contrary, when an element is referred to as being “directly on another element” or “directly connected to” another element, a middle element is not present. As used herein, “connection” can refer to physical and/or electric connection. Also, “electric connection” or “coupling” means that there can be other elements between two elements.

It should be understood that although terms “first”, “second”, “third” and the like can be used for describing various elements, components, regions, layers and/or parts, these elements, components, regions, layers and/or parts should not be limited by these terms. These terms are only used for distinguishing an element, component, region, layer or part from another element, component, region, layer or part. Therefore, “first element”, “component”, “region”, “layer” or “part” discussed hereinafter can be referred to as a second element, component, region, layer or part, without departing from the teaching herein.

In addition, relative terms such as “lower” or “bottom” and “upper” or “top” can be used for describing a relationship between an element and another element herein, as shown in the figures. It should be understood that relative terms are intended to include different orientations except orientations shown in the figures. For example, if a device in a figure overturns, it is described as an element at the “lower” sides of other elements will be oriented at the “upper” sides of the other elements. Therefore, an exemplary term “lower” can include the orientations of “upper” and “lower”, which depends on specific orientations in the figures. Similarly, if a device in a figure overturns, it is described as an element “under” other elements, or the “below” element will be oriented “above” other elements. Therefore, exemplary terms “under” or “below” can include the orientations of “upper” and “lower”.

The term “about”, “approximate” or “substantially” used herein include the value and an average value of the specific values determined by persons of ordinary skill in the art within an acceptable deviation range, considering the specific quantity of the discussed measurement and measurement-related errors (that is, the limitation of the measurement system). For example, “about” can be within one or more standard deviations of the value, or within #30%, +20%, +10% and +5%. Also, the term “about”, “approximate” or “substantially” used herein allows for the choice of acceptable deviation range or standard deviation according to optical properties, etching properties or other properties, rather than using one standard deviation to apply to all properties.

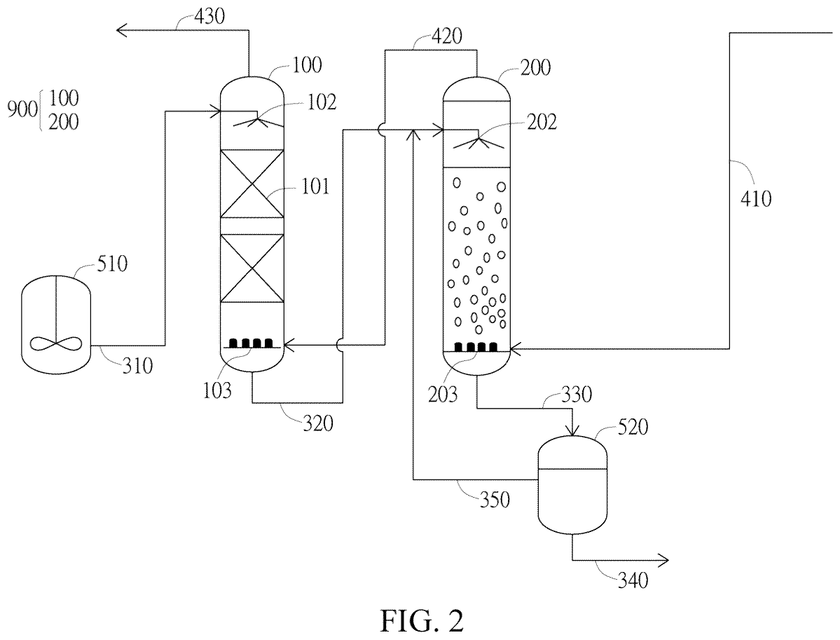

The reaction system of the present disclosure conducts carbonation reaction to capture carbon dioxide. In an embodiment as shown in FIG. 2, a reaction system 900 comprises a filler material chamber 100 and a bubble chamber 200. For example, the filler material chamber 100 of a packed bed reactor internally comprises a filler material 101. The filler material chamber 100 can be made of acrylic (poly(methyl methacrylate), PMMA), polyvinyl chloride (PVC), polycarbonate (PC) or stainless steel or the like. The filler material 101 has high specific surface area, and can be applied in random packing or structured packing. In an embodiment, the filler material chamber 100 is in a cylindrical tower shape and adopts the random packing, the filler can be a Pall ring, a Raschig ring or a Dixon θ ring, and the size of the filler is 1/10-⅙ of a tower diameter. For example, the bubble chamber 200 of the bubble bed reactor can be acrylic (poly(methyl methacrylate), PMMA), polyvinyl chloride (PVC), polycarbonate (PC) or stainless steel or the like, which are main crystallization sites of carbonate (bicarbonate) products.

As shown in FIG. 2, in an embodiment, a first liquid material flow 310 of an aqueous solution containing alkali metal ions flows out from a feed trough 510 and enters the filler material chamber 100 through a pipeline to undergo carbonation reaction to form a second liquid material flow 320 which leaves the filler material chamber 100. The second liquid material flow 320 enters the bubble chamber 200 through a pipeline to undergo carbonation reaction to form a third liquid material flow 330 which leaves the bubble chamber 200. The third liquid material flow 330 enters a recovery chamber 520 through the pipeline. Where, the feed trough 510 can be various plastic bucket troughs or is made of alkali-resistant stainless steel, and the contents flowing out, i.e. the first liquid material flow 310, can be an alkali metal hydroxide aqueous solution, an alkali metal carbonate aqueous solution and the like. In an embodiment, the first liquid material flow 310 can be an aqueous solution of alkali metal sodium ions, such as a sodium hydroxide aqueous solution, with a concentration of 10-30 wt %. The first liquid material flow 310 flows out from the bottom of the feed trough 510 into the upper end of the filler material chamber 100 and is uniformly sprayed by a liquid disperser 102 to react with a gas feed. The second liquid material flow 320 flows out from the bottom of the filler material chamber 100 into the upper end of the bubble chamber 200 and is uniformly sprayed by a liquid disperser 202 to react with the gas phase again. The third liquid material flow 330 concurrently contains solid and liquid products which are discharged from the bubble chamber 200 and enter the recovery chamber 520. The main objective of the recovery chamber 520 is that large carbonate (bicarbonate) particles can be timely discharged from the bubble chamber 200 until being accumulated, and achieve solid-liquid stratification by a gravity sedimentation method, with a level gauge arranged inside the recovery chamber 520. Where, a solid precipitate on the lower layer of the recovery chamber 520 is discharged to form a fourth liquid material flow 340, which the discharged composition contains a majority of solids and a small amount of liquids, and then the product is dried. In addition, a supernatant liquid on the upper layer of the recovery chamber 520 is discharged in a fixed ratio to form a fifth liquid material flow 350 and then enters the upper end of the bubble chamber 200 to react with the gas again. In different embodiments, the first liquid material flow 310 is not limited to flowing out from the feed trough 510, and can be provided in a batch manner or a continuous manner from other units. The third liquid material flow 330 is not limited to entering the recovery chamber 520, and can be directed to other units for further treatment or utilization.

As shown in FIG. 2, in an embodiment, a first gas material flow 410 containing carbon dioxide enters the bubble chamber 200 in a form of bubbles to undergo carbonation reaction with the second liquid material flow 320 to form a second gas material flow 420 which leaves the bubble chamber 200. The second gas material flow 420 enters the filler material chamber 100 to undergo carbonation reaction with the first liquid material flow 310 to form a third gas material flow 430 which leaves the filler material chamber 100. Where, the first gas material flow 410 is discharged from a factory's flue gas exhaust that has meet emission standard, and then enters through the gas inlet of the bubble chamber 200. The gas inlet is connected with a gas aeration disc 203, so that the first gas material flow 410 can form small bubbles to enter and uniformly disperse in the bubble chamber 200. The first gas material flow 410 can also comprise simulated flue gases in the laboratory, and a volume ratio of CO₂ can be 5-30 vol %. The second gas material flow 420 is a gas flow that remains after a part of carbon dioxide has been consumed in the bubble chamber 200, which is discharged from the upper outlet of the bubble chamber 200, and introduced from the lower gas inlet of the filler material chamber 100. The gas inlet is connected with a gas aeration disc 103, so that the second gas material flow 420 can form small bubbles to enter and uniformly disperse in the filler material chamber 100. The third gas material flow 430 is a residual gas flow after a majority of carbon dioxide is consumed by reaction again in the filler material chamber 100, which is discharged from the gas outlet above the filler material chamber 100, and connected with a carbon dioxide concentration detector to measure the concentration of carbon dioxide in the residual gas.

Furthermore, in an embodiment, the first gas material flow 410 undergoes carbonation reaction in the bubble chamber 200, and the second gas material flow 420 formed after reaction enters the filler material chamber 100 to undergo carbonation reaction so as to form the third gas material flow 430, so the concentration of carbon dioxide in the first gas material flow 410 is greater than that in the second gas material flow 420, and the concentration of carbon dioxide in the second gas material flow 420 is greater than that in the third gas material flow 430. As described above, the carbonation reaction of carbon dioxide is that a flue gas containing carbon dioxide is introduced into an alkaline solution of alkali metal hydroxide for reaction. The above reaction is composed of two steps, i.e., a reaction represented by Equation (1) and a reaction represented by Equation (2). In the reaction process, carbon dioxide initially reacts with an alkaline solution to form carbonate, and then the carbonate further reacts with carbon dioxide to form bicarbonate. Here, by taking sodium as an example of alkali metal, a total reaction equation is represented as Equation (3).

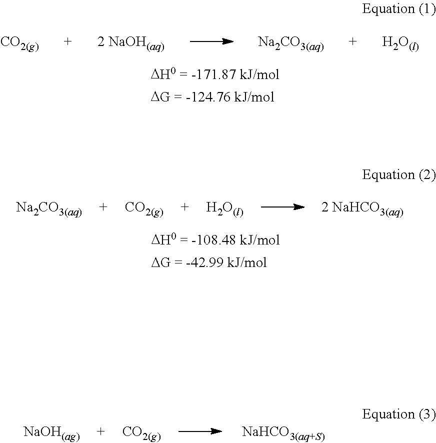

The reaction represented by Equation (1) and the reaction represented by Equation (2) are both exothermic reactions (ΔH⁰<0) and spontaneous reactions (ΔG<0), and the Gibbs energy of the reaction represented by Equation (2) is lower than that of the reaction represented by Equation (1), indicating that the reaction represented by Equation (2) is relatively slow, and this step is a rate-determining step for the entire carbonation reaction. It is considered that there is rate difference between the reaction represented by Equation (1) and the reaction represented by Equation (2), the reaction represented by Equation (1) during the entire carbonation of carbon dioxide is carried out in the filler material chamber 100; the reaction represented by Equation (2) is carried out in the bubble chamber 200, and these two reactors are connected in series. The gas and liquid in the reaction system 900 undergo a counterflow contact reaction, where a high-concentration CO₂ gas is fed from the lower end of the bubble chamber 200; an alkaline solution of alkali metal hydroxide or a carbonate aqueous solution is fed from the upper end of the filler material chamber 100. The reaction is carried out in the bubble chamber 200 by utilizing high-concentration CO₂ to accelerate the formation of bicarbonate, and the residual unreacted CO₂ enters the filler material chamber 100 again to continue reacting with the alkali metal hydroxide solution or the carbonate aqueous solution to generate the carbonate solution, so that the CO₂ gas leaving a packed bed is completely absorbed, and the carbonate (bicarbonate) precipitation product is formed at the bottom of the bubble chamber 200. In other words, the reaction system 900 of the present disclosure can simultaneously achieve two purposes of a high carbon dioxide absorption rate and a high carbonate (bicarbonate) yield by improving the reaction rate of the reaction represented by Equation (2) that is relatively slow in reaction rate and is the rate-determining step for the entire carbonation reaction, which is benefited from an early contact with a gas material flow having a high carbon dioxide concentration.

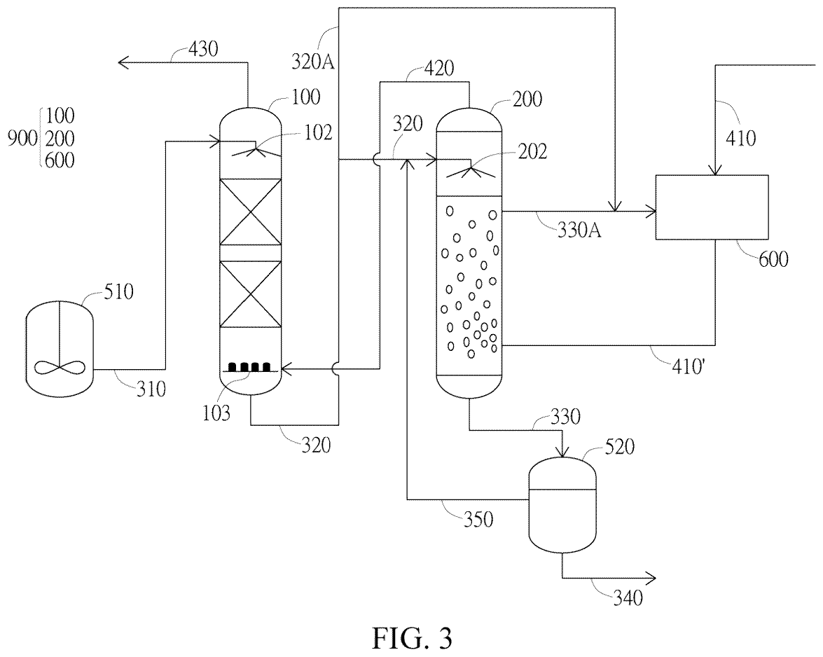

As shown in FIG. 3, in different embodiments, the reaction system 900 further comprises a microbubble generation device 600. The first gas material flow 410 enters the microbubble generation device 600 to be mixed with a part of a second liquid material flow 320A leaving the filler material chamber 100 and/or a part of a third liquid material flow 330A leaving the bubble chamber 200, and form a first gas material flow 410′ having a plurality of microbubbles which subsequently enters the bubble chamber 200 chamber. The second liquid material flow 320A and the third liquid material flow 330A can be mixed as needed to jointly enter the bubble chamber 200 to simplify the pipeline and control, or can enter the bubble chamber 200 separately and simultaneously, or can enter the bubble chamber 200 separately but not simultaneously, so as to improve operation flexibility. The first gas material flow 410′ is preferred, but is not limited to entering the bubble chamber 200 from the side wall of the bubble chamber 200. The diameter of the microbubble is less than 100 μm. Where, the microbubble generation device 600 can comprise a stirrer such as an impeller, which is used for stirring so that the first gas material flow 410 forms microbubbles. Furthermore, the microbubble generation device 600 aims to allow the gas and the liquid to be highly compatible and mixed. The reaction gas is atomized into high-density and uniform microbubbles and mixed with the liquid to form a milky white gas-liquid mixture, and then the milky white gas-liquid mixture is fed into the bubble chamber 200 by, for example, a device with a release head. Therefore, not only is the gas/liquid contact area enlarged, but also the chamber situation that a solid precipitate blocks openings and is accumulated in the bubble generation device such as the gas aeration disc can be reduced because carbon dioxide in the first gas material flow 410 forms bubbles prior to entering the bubble chamber 200.

Furthermore, in an embodiment, the bubble chamber 200 and the microbubble generation device 600 can be self-assembled into a system. Where, a part of raw liquid material flow of an aqueous solution containing alkali metal ions (for example, a second liquid material flow 320) enters the bubble chamber 200 to undergo carbonation reaction to form a product liquid material flow (for example, a third liquid material flow 330) which leaves the bubble chamber 200. A raw gas material flow containing carbon dioxide (for example, a first gas material flow 410) enters the microbubble generation device 600 to be mixed with a part of raw liquid material flow (for example, a second liquid material flow 320A) to form a plurality of microbubbles, and then enters the bubble chamber 200 to undergo carbonation reaction with the raw liquid material flow (for example, a second liquid material flow 320) to form a residual gas material flow (for example, a second gas material flow 420) which leaves the bubble chamber 200.

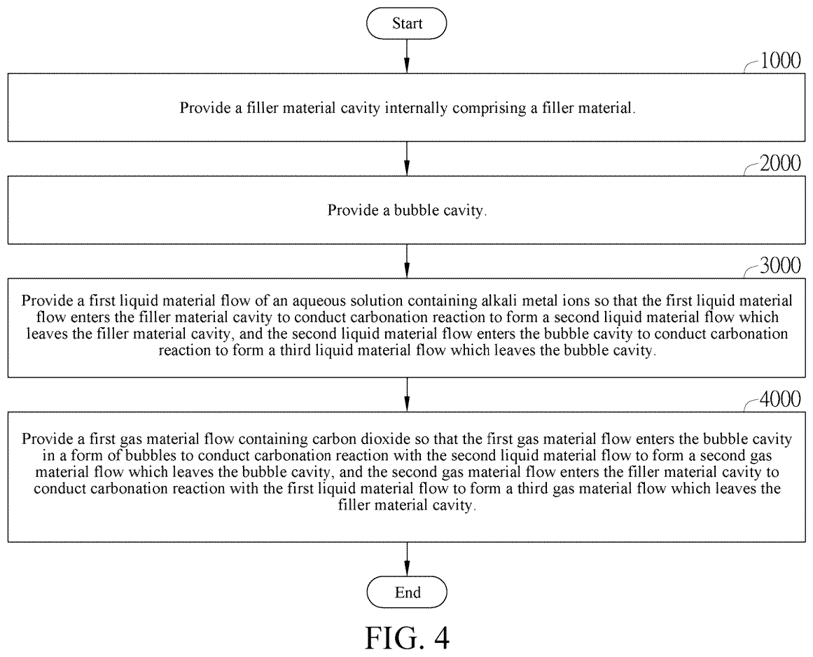

As shown in a flowchart of an embodiment as shown in FIG. 4, a reaction method for capturing carbon dioxide by carbonation reaction of the present disclosure comprises, for example, the following steps.

Step 1000: providing a filler material chamber internally comprising a filler material. More specifically, the filler material chamber 100 as shown in FIG. 3 is provided.

Step 2000: providing a bubble chamber. More specifically, the bubble chamber 200 as shown in FIG. 3 is provided.

Step 3000: providing a first liquid material flow of an aqueous solution containing alkali metal ions so that the first liquid material flow enters the filler material chamber to undergo carbonation reaction to form a second liquid material flow which leaves the filler material chamber, and the second liquid material flow enters the bubble chamber to undergo carbonation reaction to form a third liquid material flow which leaves the bubble chamber. More specifically, the first liquid material flow 310 as shown in FIG. 3 is provided, so that the first liquid material flow 310 enters the filler material chamber 100 to undergo carbonation reaction to form the second liquid material flow 320 which leaves the filler material chamber 100, and the second liquid material flow 320 enters the bubble chamber 200 to undergo carbonation reaction to form the third liquid material flow 330 which leaves the bubble chamber 200.

Step 4000: providing a first gas material flow containing carbon dioxide so that the first gas material flow enters the bubble chamber in a form of bubbles to undergo carbonation reaction with the second liquid material flow to form a second gas material flow which leaves the bubble chamber, and the second gas material flow enters the filler material chamber to undergo carbonation reaction with the first liquid material flow to form a third gas material flow which leaves the filler material chamber. More specifically, the first gas material flow 410 as shown in FIG. 3 is provided so that the first gas material flow 410 enters the bubble chamber 200 in a form of bubbles to undergo carbonation reaction with the second liquid material flow 320 to form the second gas material flow 420 which leaves the bubble chamber 200, and the second gas material flow 420 enters the filler material chamber 100 to undergo carbonation reaction with the first liquid material flow 310 to form the third gas material flow 430 which leaves the filler material chamber 100.

In an embodiment, the step 4000 comprises providing the first gas material flow that is mixed with a part of the second liquid material flow leaving the filler material chamber and forms a plurality of microbubbles. More specifically, the microbubble generation device 600 containing a stirrer such as an impeller used in an embodiment as shown in FIG. 3 is provided, in which stirring is performed so that the first gas material flow 410 forms the first gas material flow 410′ comprising microbubbles. Where, the first gas material flow 410′ enters the bubble chamber 200 from the side wall of the bubble chamber 200.

Next, the present disclosure will be described in detail through embodiments.

In embodiment 1 as shown in FIG. 2, a first liquid material flow 310 adopts an aqueous solution of alkali metal sodium ions, i.e., a 10-30 wt % sodium hydroxide aqueous solution. In this example, a 15 wt % sodium hydroxide aqueous solution with a pH value of about 14 is used, which is uniformly sprayed from the top of a filler material chamber 100 through a liquid disperser 102 to flow through the surface of a random packing with a high specific area and form a liquid membrane on the surface of the random packing to react with a residual gas flow subjected to a previous reaction, i.e., a second gas material flow 420, where the gas penetrates through a gas membrane to be absorbed by the liquid membrane and then penetrates through the liquid membrane and finally taken away by an absorption liquid flow outside the liquid membrane to undergo carbonation reaction so as to generate a second liquid material flow 320. The second liquid material flow 320 is further introduced into the bubble chamber 200, where the second liquid material flow 320 is uniformly dispersed and flows into the bubble chamber 200 through the liquid disperser 202 on the top of the bubble chamber 200 to undergo bicarbonation reaction with a CO₂-rich flue gas again. The type (sodium carbonate or sodium bicarbonate) and purity (a mixture of sodium carbonate and sodium bicarbonate) of the generated product are determined through the pH control of the third liquid material 330 after the reaction.

The first gas material flow 410 is a stimulated flue gas composed of a mixed gas in this embodiment, with a carbon dioxide content of 5-30 vol %. By taking a stimulated flue gas containing 13.8 vol % CO₂ in this embodiment as an example, the first gas material flow 410 with a total flow of 800 L/hr forms small bubbles through a gas aeration disc 203 to enter and is uniformly dispersed in the bubble chamber 200 to undergo gas-liquid-solid three-phase reaction with the second liquid material flow 320. When more and more solid products are gradually generated at the bottom of the bubble chamber 200, the third liquid material flow 330 simultaneously containing a solid and a liquid is introduced into a recovery chamber 520 so as to timely discharge large-particle carbonate (bicarbonate) until being accumulated in the recovery chamber 520. A purpose of solid-liquid stratification is achieved through a gravity sedimentation method in low energy consumption, where a liquid product in a clear supernatant on the upper layer is discharged as a fifth liquid material flow 350 in a fixed ratio into the bubble chamber 200 to be mixed with the second liquid phase material 320, and then uniformly sprayed into the bubble chamber 200 again to undergo bicarbonation reaction with CO₂, thereby further improving the yield and the purity of the product.

After the first gas material flow 410 reacts in the bubble chamber 200, there is still unreacted CO₂. The unreacted CO₂ is discharged as the second gas material flow 420 from the upper outlet of the bubble chamber 200 and then introduced from the gas inlet under the filler material chamber 100 containing the filler material 101. The gas can be uniformly dispersed onto the surface of the high-specific-area random packing inside the filler material chamber 100 containing the filler material 101 to react with the liquid membrane of the first liquid material flow 310, and the gas penetrates through the gas membrane to be absorbed by the liquid membrane to undergo carbonation reaction to generate the second liquid material flow 320 so as to form a complete reaction loop, so that carbonation reaction can be continuously carried out. At this moment, the second gas material flow 420 substantially belongs to a second reaction (a first reaction is carried out using the first gas material flow 410 in the bubble chamber 200). The third gas material flow 430 discharged from a gas outlet above the filler material chamber 100 is connected with a carbon dioxide detector to measure the concentration of residual carbon dioxide, and then the CO₂ conversion rate is calculated. To collect solid carbonate, bicarbonate or a mixed precipitate of carbonate and bicarbonate generated by reactions, the fourth liquid material flow 340 composed of carbonate (bicarbonate) solid and carbonate (bicarbonate) aqueous solution at the bottom of the recovery chamber 520 is timely collected, and the solid precipitate on the lower layer is discharged, whose composition contains a majority of solids and a small amount of liquids, which is subsequently filtered and subjected to a product drying process.

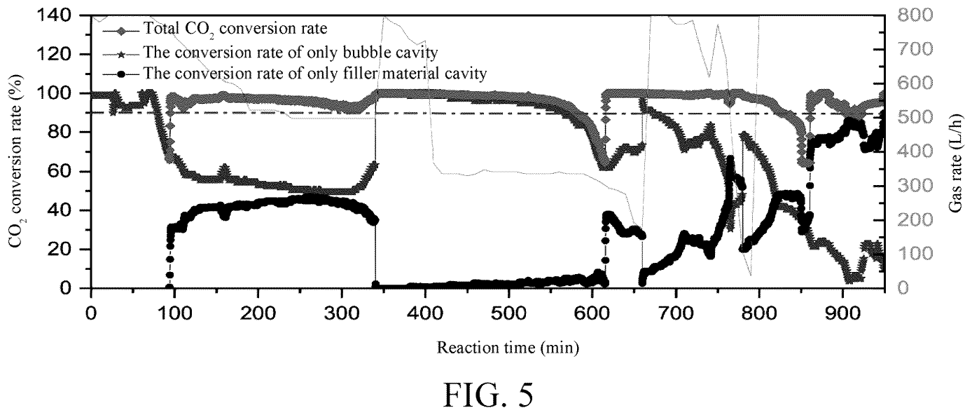

CO₂ in the flue gas forms carbonic acid (H₂CO₃) with an aqueous solution, then the carbonic acid reacts with OH⁻ ions in the aqueous solution of alkali metal sodium ions to form bicarbonate ions (HCO₃⁻), and subsequently the bicarbonate ions react with OH⁻ to form carbonate ions (CO₃²⁻). The above three reactions are all reversible reactions, so the ion concentration of the aqueous solution is dynamic rather than fixed, and the solution is in pseudo-steady state condition, that is to say, an intermediate product is immediately consumed once being formed, so the total concentration of [H₂CO₃]+[HCO₃⁻]+[CO₃²⁻] in the solution is fixed, and the molar fraction of carbonate ions can be expressed as a function of a pH value. The graph of this function illustrates that the pH value of the solution affects the CO₂ conversion rate and the purity of sodium bicarbonate. Considering the equilibrium constant and rate constant of the reaction, to achieve >95% purity of sodium bicarbonate, the pH value at the bottom of the bubble chamber where the carbonate (bicarbonate) reaction takes place should be controlled within 8.5-9.5. Based on analysis on pH value change in the reactor, a pH value of the top of the filler material chamber containing the filler material located in an injection point of an alkali liquid is about 11-12, and the pH value of the bottom is controlled to be reduced to 10.2-10.4 prior to injecting the alkali liquid into the bubble chamber for carbonate (bicarbonate) reaction. In the bubble chamber where the solid product carbonate (bicarbonate) is formed, the pH value should be maintained at <9.5, corresponding to an optimal range in which the purity of bicarbonate is more than 95%. More specifically, in embodiment 1, the reaction is conducted in the bubble chamber 200 until the final pH value is about 8.74. By analysis on the taken solid product, it is confirmed that the solid product is sodium bicarbonate with a purity of about 97%; in another aspect, as shown in FIG. 5, the total CO₂ conversion rate can also be >90% simultaneously according to this designed process. The purposes of high CO₂ conversion rate and high product purity are simultaneously achieved. Therefore, continuous feed and solid-liquid-gas three-phase reaction can be conducted for this design and carbonation reaction.

Embodiment 2 as shown in FIG. 3 is different from embodiment 1 in that the first gas material flow 410 is introduced into the microbubble generation device 600, rather than being directly introduced into the bubble chamber 200. When the gas enters the microbubble generation device 600 through an intake pipe, it is mixed with a part of second liquid material flow 320A leaving the filler material chamber 100 and/or a part of third liquid material flow 330A leaving the bubble chamber 200 and then stirred by a device, so as to generate a large amount of micron/nano bubbles with a diameter of less than 50 μm. The micro/nano bubbles have high density, do not block micropores even if the solid product is generated, which makes the devices easy to maintain. The CO₂-rich micro/nano bubbles are released into the bubble chamber 200 from a place close to the bottom of the bubble chamber 200 through a connected water outlet pipe by adopting a high-pressure vortex instantaneous release technology.

In addition, in order to increase the quantity of the micro/nano bubbles or the reaction uniformity of the micro/nano bubbles in the bubble chamber 200, one or more than one of micro/nano bubble inlets can be set, and one inlet is taken as an example in this embodiment. The micro/nano bubbles in this example are not generated through a porous gas aeration disc, so there is no blocking problem that possibly occurs when the gas-liquid-solid reaction is conducted in the bubble chamber where a porous gas aeration disc is used as a gas releaser. Furthermore, the traditional gas aeration disc is replaced with the microbubble generation device 600. A stirring blade is used in the microbubble generation device, which can be used for continuously and effectively stirring, mixing or dissolving a gas into a liquid (or a solid into a liquid), and bubbles are broken so that the gas bubble has a size of <100 μm, with an average size of 20-50 μm. Since the gas feed is not changed into small bubbles through micropores inside the microbubble generation device, there is no internal blockage phenomenon, the small bubbles of the gas feed are continuously released to the bubble chamber 200 to undergo gas-liquid reaction with the second liquid material flow 320 accumulated in the bubble chamber 200 through the high specific surface area of the generated micro/nano bubble CO₂, even if a crystal is produced at a low pH value, the outer surface of the gas aeration disc is not blocked due to accumulation, and therefore the reaction device of the present disclosure can continuously undergo gas-liquid-solid three-phase reaction.

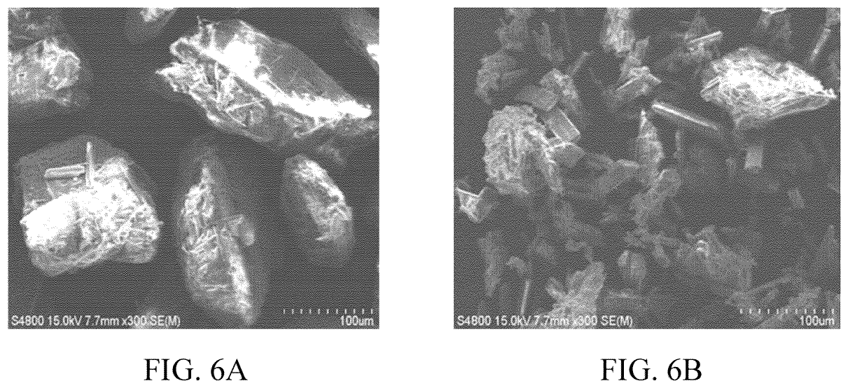

In another aspect, the second liquid material flow 320 in the liquid phase process in embodiment 2 is the same as that in embodiment 1, and can be continuously introduced into the bubble chamber 200, so the size of the generated crystal particle is the same as that in embodiment 1 as well. The dried solid product is a white crystalline granular powder whose crystal structure is an opaque monoclinic crystal system. It can be seen from the scanning electron microscopy (SEM) image of FIG. 6A that the particle size of the crystal composition is about 150-300 μm, and overall, the particle size is larger than that of the crystal composition in comparative example (see FIG. 6B), and the size is also more regular and uniform. This is because when the concentration of an alkali metal bicarbonate NaHCO₃ exceeds its saturation solubility and small crystals begin to precipitate, a high proportion of micro-granular small crystals are generated at the same time which can serve as crystal nucleus of subsequently generated sodium bicarbonate crystals. At this moment, since the gas-liquid reaction is continuously in progress, the second liquid material flow 320 with a pH value higher than that of an absorption liquid environment in the bubble chamber 200 is continuously introduced into the bubble chamber 200 in a specific amount to be uniformly sprayed into the bubble chamber 200 from above, resulting in a slight increase in the pH value of the upper edge of the bubble chamber 200, and therefore a part of crystals with a relatively small particle size are dissolved, while crystals with a relatively large particle size are retained to become the crystal nucleus of the solid crystal products formed in a continuous bicarbonation reaction between a CO₂ gas phase feed and an absorption liquid, so that subsequent crystals tend to be grown on the surfaces of the crystal nucleus, and then the particle size of the product gradually increases. Thus, this process can generate bicarbonate crystals with a large particle size, which is an advantage of the designed process of the present disclosure. Since the particle size of the product is relatively large, the subsequent separation, washing and drying operations of solid crystals are easier to carry out, which can reduce the running cost of the devices. In terms of product purity, the bubbles in gas-liquid contact utilize the design of the microbubble generation device so that there is a sufficient contact area for solid-liquid-gas three-phase reaction to continuously and stably conduct bicarbonation reaction, and therefore the pH value of the absorption liquid after reaction in the bubble chamber 200 can be stably reduced to a sufficiently low level, and there is no need to shut down the devices for cleaning due to blockage in the process. Therefore, high-purity sodium bicarbonate with a purity of >97% can be successfully obtained, just like embodiment 1.

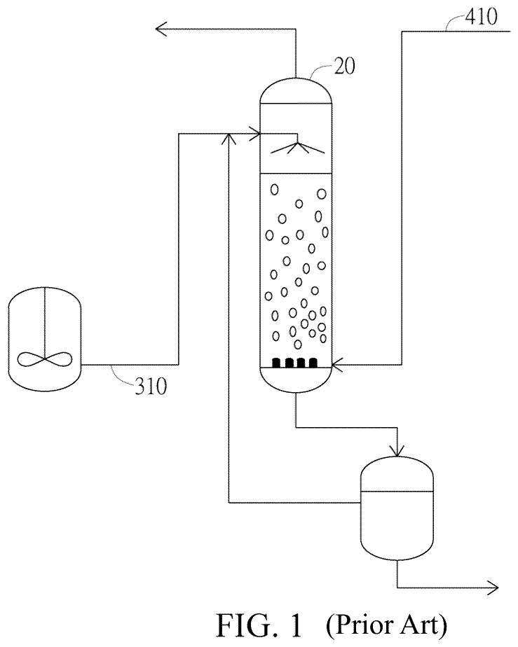

In a comparative example as shown in FIG. 1, only a single bubble reaction chamber 20 is utilized to conduct the process of the carbonation reaction of carbon dioxide. Where, the first liquid material flow 310, as described above, enters the upper end of the bubble reaction chamber 20 in a manner of spraying. The first gas material flow 410, as described above, enters the lower end of the bubble reaction chamber 20 via the gas aeration disc to form bubbles. After the reaction is performed for 500 minutes, the pH value of the absorption liquid is reduced to 9.7, while visible solid product crystals of sodium bicarbonate are precipitated, and more and more solid crystals are generated; when the reaction is performed for 650 minutes, the micropores at the inlet of the gas aeration disc have been completely blocked, and the reaction is forced to be terminated, and finally the pH value of the absorption liquid in the bubble chamber is only reduced from 14.1 to 9.6. After the generated solid product is analyzed, the purity of sodium bicarbonate is only about 84.3 wt % due to insufficient pH value decrease and incomplete reaction. The blockage phenomenon prevents the reactor from achieving continuous operation of the solid-liquid-gas three-phase reaction, and the insufficient decrease in the absorption liquid's pH leads to insufficient product purity, which are the disadvantages of this reactor design.

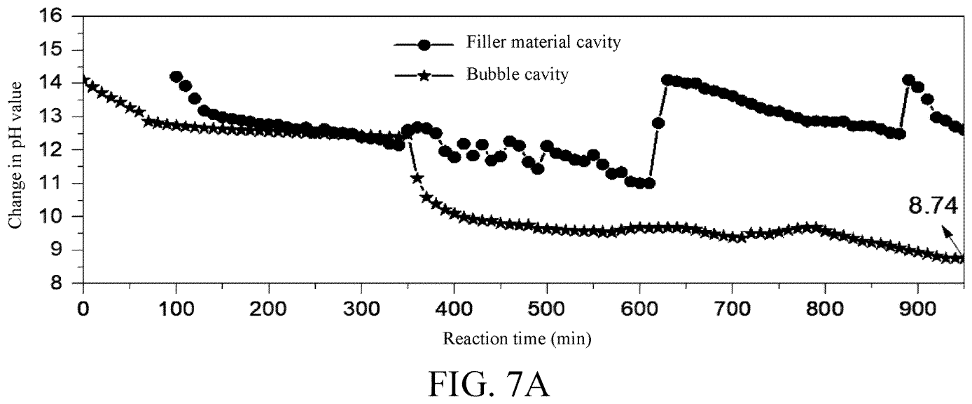

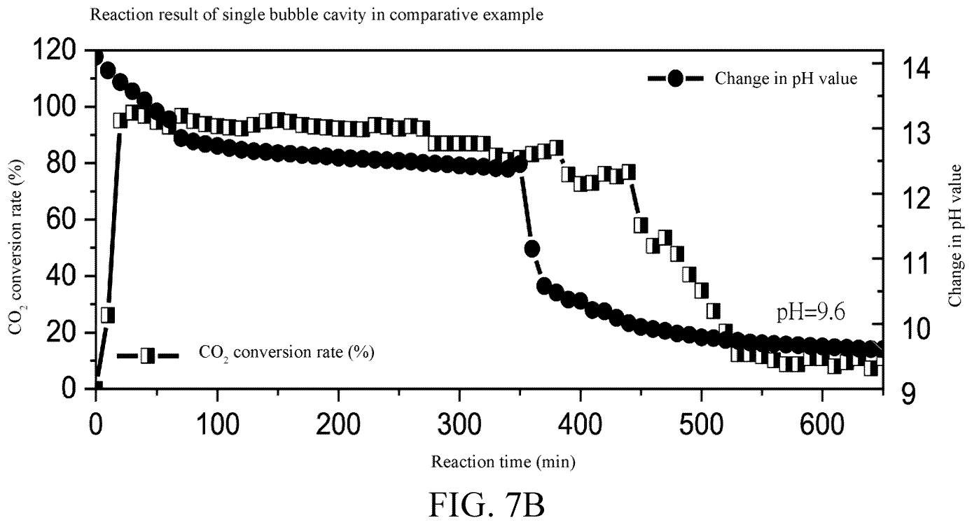

In another aspect, the reaction rate is indirectly determined by the change rate of pH. The quicker pH value decrease indicates faster reaction rates of Equation (1) and Equation (2) in which CO₂ is involved, resulting in the lower pH values, wherein more HCO₃⁻ ions are beneficial for reducing the pH to lower than 10, or even 8.5. Furthermore, the changes in pH values in the bubble cavities in embodiment 1 and the comparative example are shown in FIG. 7A and FIG. 7B, respectively. Where, the reduction of the pH value of the liquid phase in the bubble chamber in embodiment 1 from 14 to 9.6 takes about 500 minutes, and the reduction of the pH value of the liquid phase in the bubble chamber in the comparative example from 14 to 9.6 takes about 650 minutes. Therefore, it is inferred that the reaction rate in embodiment 1 is faster than that in the comparative example. In addition, it can be seen from the CO₂ conversion rate in FIG. 7B, when the pH value of the absorption liquid in the bubble chamber after carbonation reaction is reduced to <12.5, the CO₂ conversion rate has been lower than 90%; even when the pH value of the absorption liquid continues to be reduced to <10 and bicarbonation reaction tends to occurs between CO₂ and the absorption liquid, the reaction rate becomes slow and the CO₂ conversion rate is sharply reduced, and finally the CO₂ conversion rate is only about 10%. Therefore, the process design and reactor in the comparative example cannot achieve high CO₂ conversion rate and high product purity simultaneously.

It is verified from the above results that the embodiments of the device concept of the present disclosure can indeed simultaneously achieve a continuous carbon dioxide carbonation reaction with high conversion rate and fast reaction rate, proving that by the reaction system and method of the present disclosure, gas-liquid-solid three-phase crystallization reactions can be simultaneously carried out inside the bubble bed reactor, and the generated solid crystalline product cannot block a gas sprayer or is not accumulated on the gas sprayer to reduce the reaction rate and force a shutdown; and the product bicarbonate with a large particle size is obtained by using a simple device, improving its recovery rate.

The present disclosure has been described through the above related embodiments. However, the above embodiments are only examples of the present disclosure. It is noted that embodiments that have been disclosed do not limit the scope of the present disclosure. On the contrary, modifications and equivalent arrangements within the spirit and scope of the present patent claims are all included within the scope of the present disclosure.

What is claimed is:

1. A reaction system for capturing carbon dioxide through carbonation reaction, comprising:
a filler material chamber internally comprising a filler material;
a bubble chamber;
wherein, a first liquid material flow of an aqueous solution containing alkali metal ions enters the filler material chamber to undergo carbonation reaction to form a second liquid material flow which leaves the filler material chamber, and the second liquid material flow enters the bubble chamber to undergo carbonation reaction to form a third liquid material flow which leaves the bubble chamber;
a first gas material flow containing carbon dioxide enters the bubble chamber in a form of bubbles to undergo carbonation reaction with the second liquid material flow to form a second gas material flow which leaves the bubble chamber, and the second gas material flow enters the filler material chamber to undergo carbonation reaction with the first liquid material flow to form a third gas material flow which leaves the filler material chamber.

2. The reaction system according to claim 1, wherein the concentration of carbon dioxide in the first gas material flow is greater than that in the second gas material flow, and the concentration of carbon dioxide in the second gas material flow is greater than that in the third gas material flow.

3. The reaction system according to claim 1, further comprising a microbubble generation device, wherein the first gas material flow enters the microbubble generation device to be mixed with a part of the second liquid material flow leaving the filler material chamber and form a plurality of microbubbles, and then enters the bubble chamber.

4. The reaction system according to claim 3, wherein the first gas material flow enters the bubble chamber from the side wall of the bubble chamber.

5. The reaction system according to claim 3, wherein the diameter of the microbubbles is less than 100 μm.

6. The reaction system according to claim 3, wherein the microbubble generation device comprises a stirrer which is used for stirring so that the first gas material flow forms the microbubbles.

7. The reaction system according to claim 1, further comprising a microbubble generation device, wherein the first gas material flow enters the microbubble generation device to be mixed with a part of the third liquid material flow leaving the bubble chamber and form a plurality of microbubbles, and then enters the bubble chamber.

8. The reaction system according to claim 7, wherein the first gas material flow enters the bubble chamber from the side wall of the bubble chamber.

9. The reaction system according to claim 7, wherein the diameter of the microbubbles is less than 100 μm.

10. The reaction system according to claim 7, wherein the microbubble generation device comprises a stirrer which is used for stirring so that the first gas material flow forms the microbubbles.

11. The reaction system according to claim 1, wherein the first liquid material flow is an alkali metal hydroxide aqueous solution.

12. A reaction method for capturing carbon dioxide through carbonation reaction, comprising:
providing a filler material chamber internally comprising a filler material;
providing a bubble chamber;
providing a first liquid material flow of an aqueous solution containing alkali metal ions, so that the first liquid material flow enters the filler material chamber to undergo carbonation reaction to form a second liquid material flow which leaves the filler material chamber, and the second liquid material flow enters the bubble chamber to undergo carbonation reaction to form a third liquid material flow which leaves the bubble chamber;
providing a first gas material flow containing carbon dioxide, so that the first gas material flow enters the bubble chamber in a form of bubbles to undergo carbonation reaction with the second liquid material flow to form a second gas material flow which leaves the bubble chamber, and the second gas material flow enters the filler material chamber to undergo carbonation reaction with the first liquid material flow to form a third gas material flow which leaves the filler material chamber.

13. The reaction method according to claim 12, wherein the step of providing the first gas material flow comprises: providing the first gas material flow which is mixed with a part of second liquid material flow leaving the filler material chamber and forms a plurality of microbubbles.

14. The reaction method according to claim 13, comprising: allowing the first gas material flow to enter the bubble chamber from the side wall of the bubble chamber.

15. The reaction method according to claim 13, comprising: stirring so that the first gas material flow forms the microbubbles.

16. The reaction method according to claim 12, wherein the step of providing the first gas material flow comprises: providing the first gas material flow which is mixed with a part of the third liquid material flow leaving the bubble chamber and forms a plurality of microbubbles.

17. The reaction method according to claim 16, comprising: allowing the first gas material flow to enter the bubble chamber from the side wall of the bubble chamber.

18. The reaction method according to claim 16, comprising: stirring so that the first gas material flow forms the microbubbles.

19. A reaction system for capturing carbon dioxide through carbonation reaction, comprising:
a bubble chamber;
a microbubble generation device;
wherein, a part of a raw liquid material flow of an aqueous solution containing alkali metal ions enters the bubble chamber to undergo carbonation reaction to form a product liquid material flow which leaves the bubble chamber;
a raw gas material flow containing carbon dioxide enters the microbubble generation device to be mixed with a part of the raw liquid material flow and form a plurality of microbubbles, and then enters the bubble chamber to undergo carbonation reaction with the raw liquid material flow to form a residual gas material flow which leaves the bubble chamber.

20. The reaction system according to claim 19, wherein the raw gas material flow enters the bubble chamber from the side wall of the bubble chamber.
